(19) United States
(12) Patent Application Publication
(10) Pub. No.: US 2004/0001074 A1
(43) Pub. Date: Jan. 1, 2004

(54) Image display apparatus and method, transmitting apparatus and method, image display system, recording medium, and program

(76) Inventor: Hideki Oyaizu, Tokyo (JP)

Correspondence Address: BELL, BOYD & LLOYD, LLC, P. O. BOX 1135, CHICAGO, IL, 60690-1135, US

(21) Appl. No.: 10/446,557

(22) Filed: May 28, 2003

(30) Foreign Application Priority Data
May 29, 2002 (JP) P2002-155647

(51) Int. Cl. G09G 5/00

(52) U.S. Cl. 345/633; 345/629

(57) ABSTRACT

In an image display system, optical beacons are arranged to become vertices of a rectangle on a wall. An external image is transformed in accordance with the shape of an external image display area defined by the optical beacons on an image capturing area. Subsequently, the external image is merged with the external image display area and the merged image is displayed. The position at which the external image display area is displayed is changed in accordance with the movement of an image display unit and the movement of the image capturing area.

### BACKGROUND OF THE INVENTION

The present invention relates to image display apparatuses and methods, transmitting apparatuses and methods, image display systems, recording media, and programs. More particularly, the present invention relates to an image display apparatus and method, a transmitting apparatus and method, an image display system, a recording medium, and a program for displaying an image as if it were displayed on an object in real space. Nowadays, large-screen television sets and projectors are used to enable viewers to appreciate television broadcast images with high realism and impressive quality. Since these products are expensive and large and occupy a large amount of space, these products are not widely used among users who do not have enough space available. There is an increasing demand for television sets that enable users to appreciate television broadcast images with high realism and impressive quality even in a small space.

In response to this demand, an apparatus is proposed that displays a video image on a head mounted display (HMD), thus enabling the user to feel as if a large display were provided before the user's eyes. The HMD is an eyeglass-like display. The user wears this eyeglass-like display as if wearing eyeglasses and becomes able to experience an impressive sense of realism just as if the images were displayed on a large display. Since the HMD is an eyeglass-like display, the user can view displayed images in any posture.

The above-described HMD only displays predetermined images and cannot display images responsive to the HMD's movement. For example, if the user moves his/her head, the image displayed on the HMD is unresponsive to the movement of the head (the image does not change even when the head moves). Since the same image is displayed on the left and right eyeglasses, the user cannot perceive a sense of distance based on parallax. As a result, the HMD only makes the user feel as if a small display, whose size is equivalent to a pair of eyeglasses, is provided before the user's eyes, rather than making the user feel as if the user were looking at a large-screen display. Therefore, the user may think that the HMD fails to provide high realism and impressive quality.

The user wearing the HMD (looking at images displayed on the HMD) is isolated from the external world since the display portions cover the user's eyes. As a result, the user may feel as if he or she were confined in a small and enclosed space. In view of this, a system has been proposed where a display is provided with a “see-through” or transparent portion enabling the user to see the external world. Since an image is displayed at the center of such a display, there is almost no transparent portion to see the external world. Therefore, this system does not provide much of an improvement.

Technology referred to as augmented reality (AR) has been proposed. AR merges an image captured by a camera aligned with the user's view with another image to create a merged image in which the directions and positions of the two images are matched with each other. Using AR, an image of a large screen is captured as an image in real space, and a desired image is merged with the captured screen image, thus representing the desired image as if it were displayed on a large screen.

This method involves arranging beforehand three or more markers defining three-dimensional positions in an image captured by a camera that is aligned with the user's view. Therefore, preliminary calibration involving measuring the positions of the given markers is necessary. AR technology thus cannot actually be applied to domestic use.

### SUMMARY OF THE INVENTION

Accordingly, it is an object of the present invention to display an image with high realism and impressive quality by displaying the image as if it were displayed on a portion in real space.

According to an aspect of the present invention, an image display apparatus is provided including an image capturing unit for capturing an image of a plurality of transmitting apparatuses that emit light in predetermined flashing patterns to transmit data; a detector for detecting the image-captured positions of the plurality of transmitting apparatuses, the image being captured by the image capturing unit; an input unit for inputting a first image; a transformer for transforming the first image on the basis of the image-captured positions of the transmitting apparatuses, the image-captured positions being detected by the detector; and a display unit for displaying the first image transformed by the transformer at a display position associated with the image-captured positions of the transmitting apparatuses.

The image display apparatus may further include an analyzer for analyzing the data included in the predetermined flashing patterns emitted by the plurality of transmitting apparatuses. The data may include link data, content data, or group data indicating a group to which the plurality of transmitting apparatuses belong. The link data may include a link target on a network, at which information on the first information resides.

The image display apparatus may further include an obtaining unit for accessing the link target included in the link data and obtaining the first image. The content data may include information on the first image. The input unit may input the first image included in the content data.

The transformer may transform the first image on the basis of the captured-image positions of four transmitting apparatuses including the same group data. When the first image is a quadrilateral, the display unit may display the first image transformed by the transformer at the display position so that four corners of the first image are associated with the image-captured positions of the four transmitting apparatuses. The image capturing unit may capture a second image, in addition to the image of the plurality of transmitting apparatuses emitting light in the predetermined flashing patterns to transmit the data.

The image display apparatus may further include a merged image generator for merging the second image with the first image transformed by the transformer and generating a merged image. The display unit may display the merged image so that the first image included in the merged image is displayed at the display position associated with the image-captured positions of the transmitting apparatuses.

The display unit may include a transparent screen; and a light-shielded-area generator for generating a light-shielded area at the display position associated with the image-captured positions of the transmitting apparatuses on the screen. The first image transformed by the transformer may be displayed in the light-shielded area.

The image-capturing unit, the input unit, the transformer, and the display unit may be provided in pairs for the human eyes. The refresh rate of the image-capturing unit may be higher than the refresh rate of the display unit. The transformer may transform the first image by projective transformation based on the image-captured positions of the transmitting apparatuses.

According to another aspect of the present invention, an image display method is provided including an image capturing step of capturing an image of a plurality of transmitting apparatuses that emit light in predetermined flashing patterns to transmit data; a detection step of detecting the image-captured positions of the plurality of transmitting apparatuses, the image being captured in the image capturing step; an input step of inputting a first image; a transformation step of transforming the first image on the basis of the image-captured positions of the transmitting apparatuses, the image-captured positions being detected in the detection step; and a display step of displaying the first image transformed in the transformation step at a display position associated with the image-captured positions of the transmitting apparatuses.

According to a further aspect of the present invention, a first recording medium having recorded thereon a program is provided. The program includes an image capturing control step of controlling capturing of an image of a plurality of transmitting apparatuses that emit light in predetermined flashing patterns to transmit data; a detection control step of controlling detection of the image-captured positions of the plurality of transmitting apparatuses, the image capturing being controlled in the image capturing control step; an input control step of controlling inputting of a first image; a transformation control step of controlling transformation of the first image on the basis of the image-captured positions of the transmitting apparatuses, the detection of the image-captured positions being controlled in the detection control step; and a display control step of controlling displaying of the transformed first image, whose transformation is controlled in the transformation control step, at a display position associated with the image-captured positions of the transmitting apparatuses.

According to yet another aspect of the present invention, a program for causing a computer to perform a process is provided. The process includes an image capturing control step of controlling capturing of an image of a plurality of transmitting apparatuses that emit light in predetermined flashing patterns to transmit data; a detection control step of controlling detection of the image-captured positions of the plurality of transmitting apparatuses, the image capturing being controlled in the image capturing control step; an input control step of controlling inputting of a first image; a transformation control step of controlling transformation of the first image on the basis of the image-captured positions of the transmitting apparatuses, the detection of the image-captured positions being controlled in the detection control step; and a display control step of controlling displaying of the transformed first image, whose transformation is controlled in the transformation control step, at a display position associated with the image-captured positions of the transmitting apparatuses.

According to another aspect of the present invention, a transmitting apparatus is provided including a pattern generator for generating a predetermined flashing pattern associated with data; and a light-emitting unit for emitting light in the predetermined flashing pattern generated by the pattern generator. The data may include link data, content data, or group data indicating a group to which the transmitting apparatus belongs. The link data may include a link target on a network, at which information on an image displayed on an image display apparatus resides. The content data may include information on an image displayed on an image display apparatus.

According to a further aspect of the present invention, a transmitting method is provided including a pattern generating step of generating a predetermined flashing pattern associated with data; and a light-emitting step of emitting light in the predetermined flashing pattern generated in the pattern generating step.

According to yet another aspect of the present invention, a second recording medium having recorded thereon a program is provided. The program includes a pattern generation control step of controlling generation of a predetermined flashing pattern associated with data; and a light-emission control step of controlling emission of light in the predetermined flashing pattern generated in the pattern generation control step.

According to another aspect of the present invention, a program for causing a computer to perform a process is provided. The process includes a pattern generation control step of controlling generation of a predetermined flashing pattern associated with data; and a light-emission control step of controlling emission of light in the predetermined flashing pattern generated in the pattern generation control step.

According to a further aspect of the present invention, an image display system is provided including an image display apparatus and a transmitting apparatus. The image display apparatus includes an image capturing unit for capturing an image of a plurality of transmitting apparatuses that emit light in predetermined flashing patterns to transmit data; a detector for detecting the image-captured positions of the plurality of transmitting apparatuses, the image being captured by the image capturing unit; an input unit for inputting an image; a transformer for transforming the image on the basis of the image-captured positions of the transmitting apparatuses, the image-captured positions being detected by the detector; and a display unit for displaying the image transformed by the transformer at a display position associated with the image-captured positions of the transmitting apparatuses. The transmitting apparatus includes a pattern generator for generating the predetermined flashing pattern associated with the data; and a light-emitting unit for emitting light in the predetermined flashing pattern generated by the pattern generator.

According to an image display apparatus and method and a program therefor of the present invention, an image of transmitting apparatuses that emit light in predetermined flashing patterns to transmit data is captured.. The image-captured positions of the transmitting apparatuses are detected. A first image is input. The first image is transformed on the basis of the image-captured positions of the transmitting apparatuses. The transformed first image is displayed at a display position associated with the image-captured positions of the transmitting apparatuses.

According to a transmitting apparatus and method and a program therefor of the present invention, a predetermined flashing pattern associated with data is generated. Light is emitted in the generated predetermined flashing pattern.

According to an image display system of the present invention, an image display apparatus captures an image of transmitting apparatuses that emit light in predetermined flashing patterns to transmit data, detects the image-captured positions of the plurality of transmitting apparatuses, inputs an image, transforms the image on the basis of the detected image-captured positions of the transmitting apparatuses, and displays the transformed image at a display position associated with the image-captured positions of the transmitting apparatuses. Each of the transmitting apparatuses generates the predetermined flashing pattern associated with the data and emits light in the generated predetermined flashing pattern.

According to the present invention, an external image is merged and displayed on a captured image as if the image were displayed on a surface of an object in real space.

Additional features and advantages of the present invention are described in, and will be apparent from, the following Detailed Description of the Invention and the figures.

### BRIEF DESCRIPTION OF THE DRAWINGS

FIG. 1 is a block diagram of an image merging display system according to an embodiment of the present invention;

FIG. 2 is a block diagram of an ID recognizing camera shown in FIG. 1;

FIG. 3 is a block diagram of an image decoding processor shown in FIG. 2;

FIG. 4 is a block diagram of an ID decoding processor shown in FIG. 2;

FIG. 5 is a block diagram of an optical beacon shown in FIG. 1;

FIG. 6 is a block diagram of the optical beacon shown in FIG. 1;

FIG. 7 is a diagram for describing the operation of the ID recognizing camera;

FIG. 8 is a diagram for describing the operation of the ID recognizing camera generating an image signal;

FIG. 9 is a diagram for describing the operation of the ID recognizing camera generating the image signal;

FIG. 10 is an illustration for describing the operation of the ID recognizing camera decoding a flashing pattern;

FIG. 11 is a flowchart of an image merging display process;

FIG. 12 is a flowchart of an image transforming process;

FIG. 13 is an illustration of the image transforming process;

FIG. 14 is an illustration of the image transforming process;

FIG. 15 is an illustration of the image transforming process;

FIG. 16 is an illustration of an image merging process;

FIG. 17 is an illustration of an HMD using image merging display apparatuses;

FIG. 18 is a block diagram of another configuration of the image merging display apparatus;

FIG. 19 is an illustration of an example in which optical beacons are arranged on a curved surface of a vase;

FIG. 20 is an illustration of the optical beacon arrangement and parameters of an external image;

FIG. 21 is an illustration of the external image;

FIG. 22 is a flowchart of the image merging display process;

FIG. 23 is an illustration of an example in which the external image is merged and displayed;

FIG. 24 is a block diagram of another configuration of the image merging display apparatus;

FIG. 25 is a flowchart of the image merging display process;

FIG. 26 is an illustration of an example in which a plurality of external images are merged and displayed;

FIG. 27 is a diagram showing media; and

FIG. 28 is a diagram showing media.

### DESCRIPTION OF THE PREFERRED EMBODIMENTS

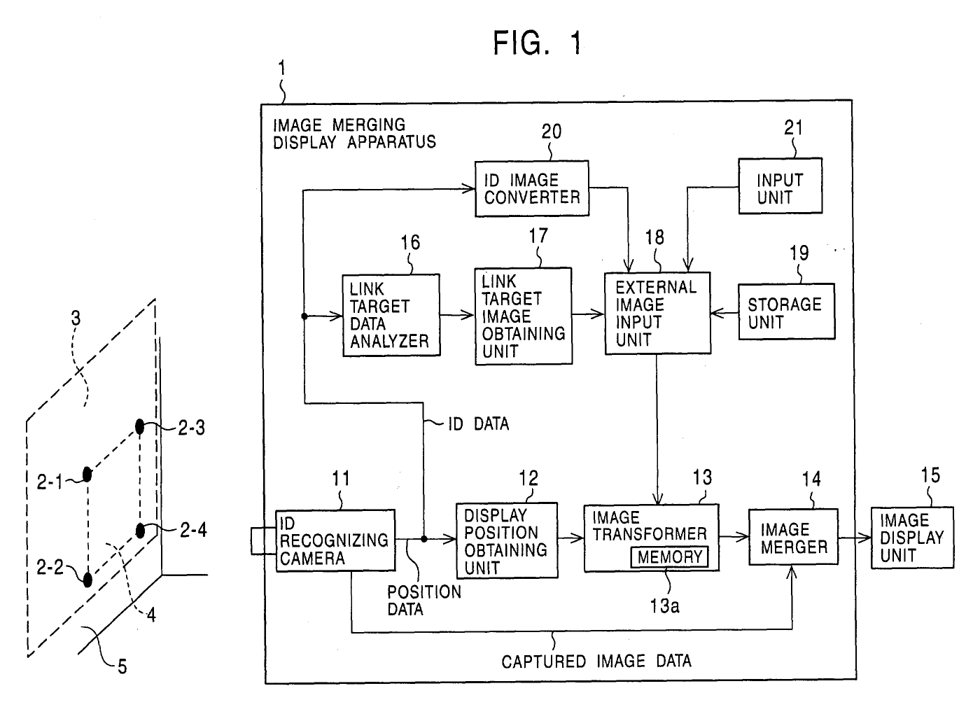

FIG. 1 is a block diagram of the configuration of an image merging display system according to an embodiment of the present invention. The image merging display system includes an image merging display apparatus 1 and optical beacons 2-1 to 2-4.

When the image merging display apparatus 1 of the image merging display system captures an image of an image capturing area (an area that becomes an actually displayed image) including the optical beacons 2-1 to 2-4, the image merging display apparatus 1 recognizes an external image display area 4 defined by the optical beacons 2-1 to 2-4 on the image capturing area 3, transforms an external image so as to fit the external image display area 4, merges the external image with the image capturing area 3, and finally displays the resultant image on an image display unit 15. In other words, the image merging display apparatus 1 uses the external image display area 4 defined by the optical beacons 2-1 to 2-4 in real space, as if the external image display area 4 were a screen arranged in real space, and merges an external image with a captured image to display a merged image.

The optical beacons 2-1 to 2-4 transmit data by emitting light using predetermined light-emitting patterns. The data is referred to as ID data for discriminating among the optical beacons 2-1 to 2-4. Since the data capacity that can be transferred by the optical beacons 2-1 to 2-4 provides some extra space, the optical beacons 2-1 to 2-4 can transmit additional data. For example, the ID data can include content data (image data, audio data, text data, or the like), link target data (URL (Uniform Resource Locator), address, host name, or the like), and group identifying data for identifying a group to which each of the optical beacons 2-1 to 2-4 belongs. The ID data is not limited to the above-described types of data. The optical beacons 2-1 to 2-4 can transmit any data that can be handled as electronic data. As discussed above, the optical beacons 2-1 to 2-4 can transmit not only the ID data but also various types of data by changing the light-emitting patterns.

The group identifying data for identifying a group to which each of the optical beacons 2-1 to 2-4 belongs will now be described. For example, referring to FIG. 1, there is only one external image display area 4. If there is a plurality of external image display areas, a set of the plural optical beacons 2 defining the individual external image display area 4 is referred to as a group, and data for identifying the group is referred to as the group identifying data. In this case, the optical beacons 2-1 to 2-4 belong to the same group, and the same group identifying data is thus transmitted. A case in which a plurality of external images is displayed will be described later. It is assumed that the optical beacons 2-1 to 2-4 are arranged to form the vertices of a rectangle on a wall 5.

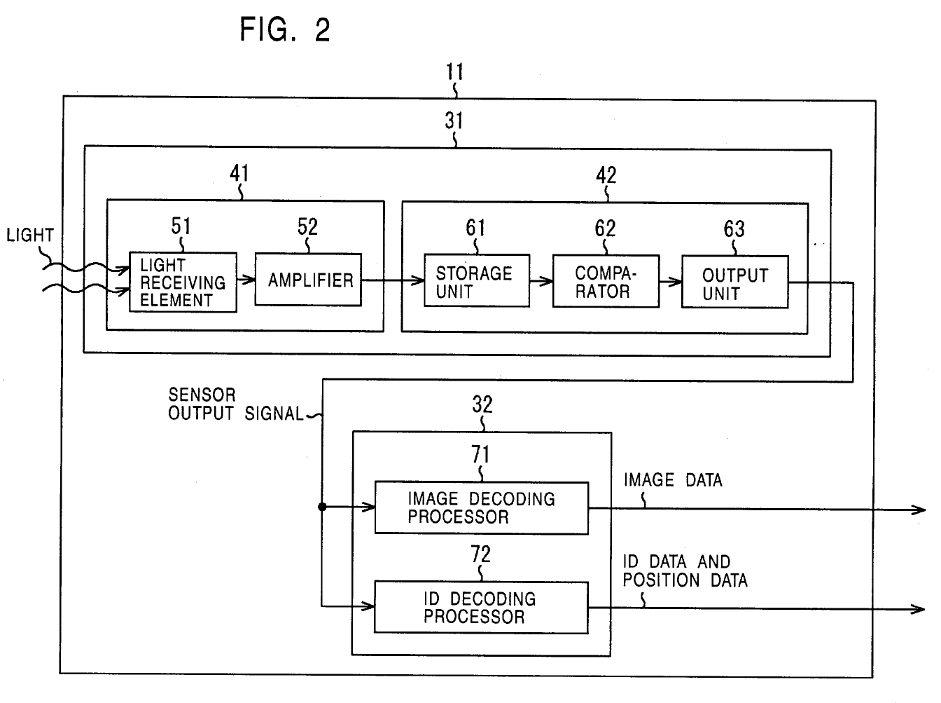

In the following description, when it is unnecessary to distinguish among the optical beacons 2-1 to 2-4, they are collectively referred to as the optical beacons 2. The same applies to the other components. An ID (Identifier) recognizing camera 11 and the optical beacons 2 will be described later with reference to FIGS. 2 to 10.

The configuration of the image merging display apparatus 1 will now be described. The ID recognizing camera 11 outputs image data generated by capturing an image of the above-described image capturing area 3 to an image merger 14, generates ID data and position data from the light-emitting patterns emitted from the captured optical beacons 2 (whose image has been captured), and outputs the ID data to a link target data analyzer 16 and an ID image converter 20 and the image-captured position data to a display position obtaining unit 12. The display position obtaining unit 12 obtains the position data indicating the positions of the optical beacons 2-1 to 2-4 in the image capturing area 3 and outputs the positions as displayed position information on the external image display area 4 to an image transformer 13.

Of the data transmitted along with the light-emitting patterns of the optical beacons 2, the link target data analyzer 16 analyzes the ID data and, if the ID data includes link target data, the link target data analyzer 16 extracts the link target data and outputs the link target data to a link target image obtaining unit 17.

The link target image obtaining unit 17 includes, for example, a modem. The link target image obtaining unit 17 accesses a link target via a network (not shown), such as the Internet, on the basis of the link target data received from the link target data analyzer 16, obtains an external image stored at the link target, and outputs the obtained external image to an external image input unit 18.

When the ID data includes an external image serving as content data, the ID image converter 20 converts the ID data into the external image (extracts the external image from the ID data) and outputs the external image to the external image input unit 18. A storage unit 19 stores a pre-received external image and supplies the stored external image to the external image input unit 18.

The external image input unit 18 reads the external image designated by the user by operating an input unit 21, the designated external image being one of the external image obtained from the link target, the external image included in the ID data received from the ID image converter 20, and the external image stored in the storage unit 19, and outputs the external image to the image transformer 13.

The image transformer 13 appropriately uses a memory 13a and obtains the shape of the external image display area 4 (the shape on a captured image) from the image-captured positions of the optical beacons 2-1 to 2-4, which are received from the display position obtaining unit 12, transforms the external image received from the external image input unit 18 so as to fit the obtained shape, and outputs the transformed external image to the image merger 14.

The image merger 14 merges an image captured by the ID recognizing camera 11 (image of the image capturing area 3) with the transformed external image, that is, merges the transformed external image, which is transformed to fit the external image display area 4, with the captured image of the image capturing area 3, outputs the resultant image to the image display unit 15, and displays the resultant image.

Referring to FIG. 2, the detailed configuration of the ID recognizing camera 11 will now be described. A light receiving section 41 of an image sensor 31 performs photoelectric conversion of light from the image capturing area 3, an image of which is to be captured, into an electrical signal and outputs the electrical signal to an arithmetic unit 42. A light receiving element 51 of the light receiving section 41 includes a CMOS (Complementary Metal-Oxide Semiconductor) element and operates at a higher speed than a known CCD (Charge Coupled Device) element. More specifically, the light receiving element 51 performs photoelectric conversion of light from the image capturing area 3, an image of which is to be captured, and outputs the resultant electrical signal to an amplifier 52. The amplifier 52 amplifies the electrical signal, which is generated by photoelectric conversion and received from the light receiving element 51, and outputs the amplified signal to the arithmetic unit 42.

A storage unit 61 of the arithmetic unit 42 stores the amplified electrical signal, which is received from the light receiving section 41, and appropriately outputs the electrical signal to a comparator 62. The comparator 62 performs an arithmetic operation based on the value of the electrical signal stored in the storage unit 61, compares the operation result with a predetermined reference value (=reference signal level), and outputs the comparison result to an output unit 63. The output unit 63 generates a sensor output signal on the basis of the comparison result and outputs the sensor output signal to a data generator 32. The content of the processing by the arithmetic unit 42 differs in two operation modes, namely, an image mode and an ID mode. The content of the processing in two different operation modes will be described in detail below.

In the image mode, an image decoding processor 71 of the data generator 32 decodes the sensor output signal to generate a captured image and outputs the captured image to the image merger 14. In the ID mode, an ID decoding processor 72 decodes the sensor output signal to generate ID data and position data and outputs the ID data to the link data analyzer 16 and the ID image converter 20 and the position data to the display position obtaining unit 12.

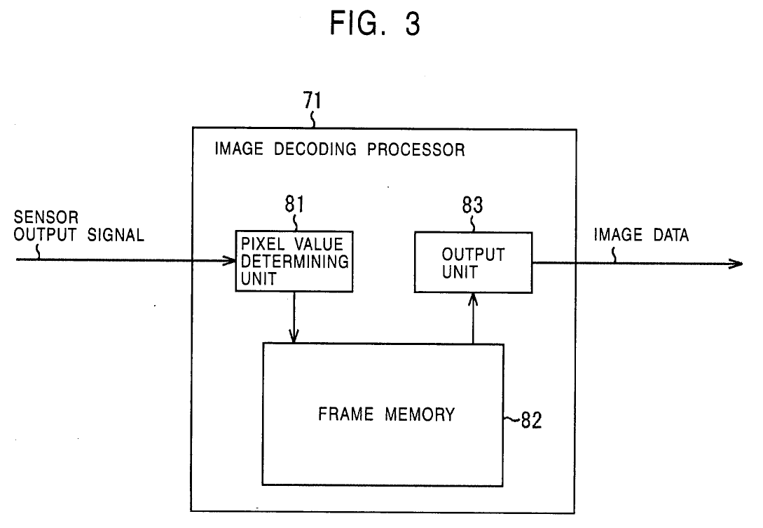

Referring to FIG. 3, the detailed configuration of the image decoding processor 71 will now be described. A pixel value determining unit 81 of the image decoding processor 71 determines a pixel value on the basis of the sensor output signal and stores the determined pixel value at a corresponding pixel position in a frame memory 82. The frame memory 82 stores pixel values over one frame. The frame memory 82 stores the pixel value at each pixel position. When the pixel values over one frame are stored in the frame memory 82, an output unit 83 sequentially reads and outputs the pixel values as pixel data.

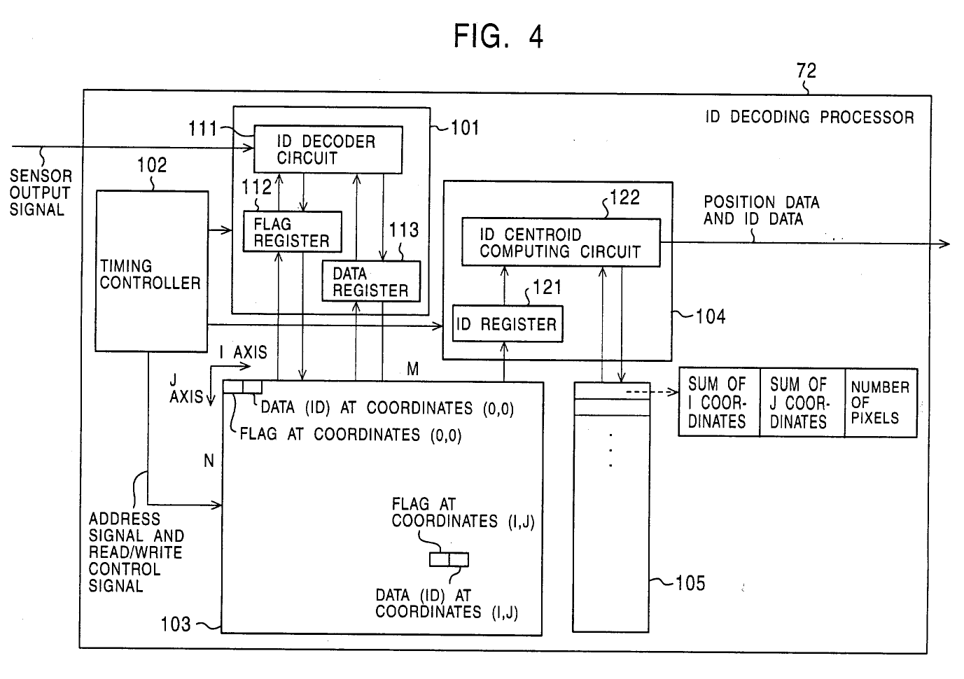

Referring to FIG. 4, the detailed configuration of the ID decoding processor 72 will now be described. An ID decoder circuit 111 of an ID decoder 101 includes devices, such as an IC (Integrated Circuit), ASIC (Application Specific Integrated Circuit), FPGA (Field Programmable Gate Array), and the like. The ID decoder circuit 111 restores each pixel's ID data from the sensor output signal received from the image sensor 31. When a microprocessor or a DSP (Digital Signal Processor) has sufficient throughput, the ID decoder circuit 111 may include such a microprocessor or DSP using software. A flag register 112 stores flags necessary for decoding the ID data. A data register 113 stores an ID being decoded or a decoded ID.

Referring to FIG. 4, only one ID decoder 101 is shown. Alternatively, for example, the ID decoder 101 may be provided for each pixel, depending on the required processing speed. Alternatively, the ID decoder 101 may be provided for each line in the vertical direction or the horizontal direction.

A timing controller 102 outputs a timing control signal for controlling the timing required for the overall operation of the ID decoding processor 72. More specifically, the timing controller 102 synchronizes the timing of the sensor output signal with the ID decoder circuit 111. In response to a desired sensor output signal, the timing controller 102 generates a timing control signal for loading corresponding flag data and ID data in a frame memory 103 into the flag register 112 and the data register 113, respectively, and for carrying out ID decoding and supplies the timing control signal to the ID decoder 101 (namely, the ID decoder circuit 111, the flag register 112, and the data register 113 in the ID decoder 101). At the same time, the timing controller 102 generates and supplies an address signal and a read/write timing control signal to the frame memory 103. Also, the timing controller 102 generates and supplies a timing control signal for controlling the timing to an ID register 121 and an ID centroid computing circuit 122 in a centroid calculator 104 and to an ID coordinate storage memory 105.

The frame memory 103 stores the ID data and the flag data generated by decoding the sensor output signal computed for each light receiving element 51 or each arithmetic unit 42. When the image sensor 31 has one arithmetic unit 42 for each pixel, the frame memory 103 has the same size as that of the image size of the image sensor 31, that is, M pixel×N pixel. The data width of the frame memory 103 is the sum of the bit width of the flag register 112 and the bit width of the data register 113. Referring to FIG. 4, the coordinates corresponding to the position of each pixel are represented by the I axis and the J axis. At each coordinate position, the ID data and the flag data are stored.

The centroid calculator 104 calculates the coordinates at the centroid position of pixels on a captured image, the pixels having the same ID data, adds the position data serving as the detected positions of the optical beacons 2 (position data on the optical beacons 2 on the captured image) to the ID data, and outputs the resultant data. More specifically, the ID register 121 of the centroid calculator 104 reads ID data stored in the frame memory 103 on the basis of a timing control signal that is received from the timing controller 102 and that indicates that predetermined ID data is decoded by the ID decoder 101 and outputs the read ID data to the ID centroid computing circuit 122. For each piece of the received ID data, the ID centroid computing circuit 122 sequentially adds the I coordinates and the J coordinates at the coordinate positions of the corresponding pixels and the number of pieces of data (the number of pixels) and stores the sums in the ID coordinate storage memory 105. When the data over one frame is stored in the frame memory 103, for each ID, the ID centroid computing circuit 122 divides the sum of the I coordinates and the sum of the J coordinates in the ID coordinate storage memory 105 by the number of pieces of data (the number of pixels), thus computing the coordinates at the centroid position, and outputs the coordinates along with the ID data.

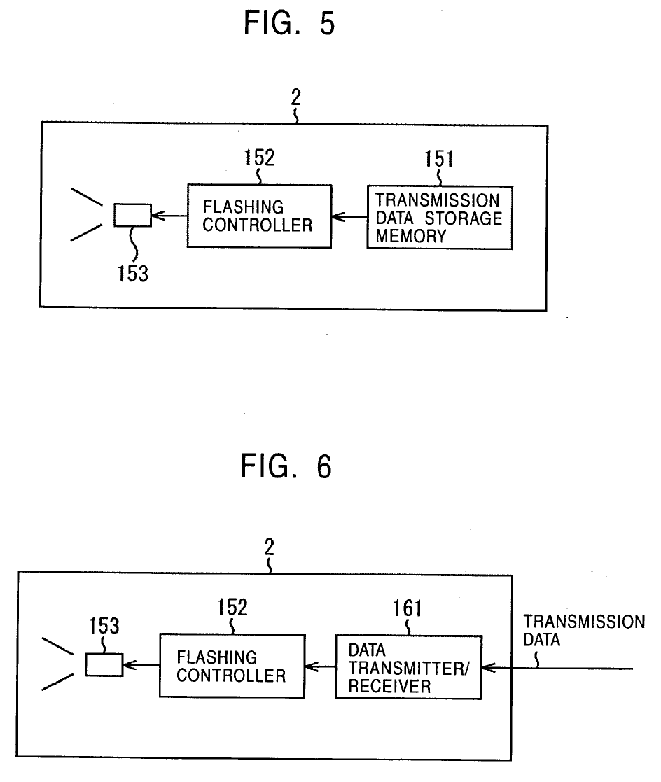

With reference to FIGS. 5 and 6, the configuration of each of the optical beacons 2 will now be described. The optical beacon 2 shown in FIG. 5 includes a transmission data storage memory 151, a flashing controller 152, and a light emitting unit 153. The transmission data storage memory 151 stores in advance transmission data. The transmission data storage memory 151 appropriately reads the transmission data and outputs the read transmission data to the flashing controller 152. The flashing controller 152 includes a transmitter and digital circuits including an IC, ASIC, FPGA, and one-chip microcomputer. On the basis of the content of the data stored in the transmission data storage memory 151, the flashing controller 152 generates a flashing pattern and causes the light emitting unit 153 to emit light in accordance with the generated flashing pattern. The light emitting unit 153 only needs to function as a light source that flashes on and off at high speed. The output wavelength of the light emitted by the light emitting unit 153 only needs to be within a sensor responsive range of the image sensor 31. Light emitted by the light emitting unit 153 includes not only visible light but also infrared light. In view of the response speed and life, an LED (Light Emission Diode) is one optimal light source.

FIG. 6 shows another configuration of the optical beacon 2 for changing data by communicating with another apparatus via a network (not shown). Referring to FIG. 6, the optical beacon 2 includes, in place of the transmission data storage memory 151, a data transmitter/receiver 161. The network refers to an environment that enables data communication with another apparatus via a communication medium such as a wired or wireless communication line, e.g., a telephone line, ISDN (Integrated Services Digital Network), RS-232C, RS-422, Ethernet(R) (10 base-T and 100 base-T), USB (Universal Serial Bus), IEEE (Institute of Electrical and Electronics Engineers) 1394, IEEE 802.11a, IEEE 802.11b, and Bluetooth. The data transmitter/receiver 161 includes a data communication IC and a driver corresponding to the communication medium. The data transmitter/receiver 161 outputs transmission data received from the optical beacon 2 via the network to the flashing controller 152. The flashing on/off controller 152 generates a flashing pattern on the basis of the transmission data and causes the light emitting unit 153 to flash on/off in accordance with the flashing pattern associated with the data.

The operation of the ID recognizing camera 11 will now be described. The light receiving element 51 of the light receiving section 41 performs photoelectric conversion of light into an electrical signal and outputs the electrical signal to the amplifier 52. The amplifier 52 amplifies the electrical signal and outputs the amplified signal to the arithmetic unit 42. The storage unit 61 of the arithmetic unit 42 sequentially stores electrical signals received from the light receiving section 41 and stores the electrical signals over four frames. When the storage unit 61 becomes full, the storage unit 61 erases an electrical signal in the oldest frame and stores an electrical signal in the most recent frame. This operation is repeated to allow the storage unit 61 to store electrical signals over the most recent four frames at all times. The storage unit 61 outputs the electrical signals over the four frames to the comparator 62.

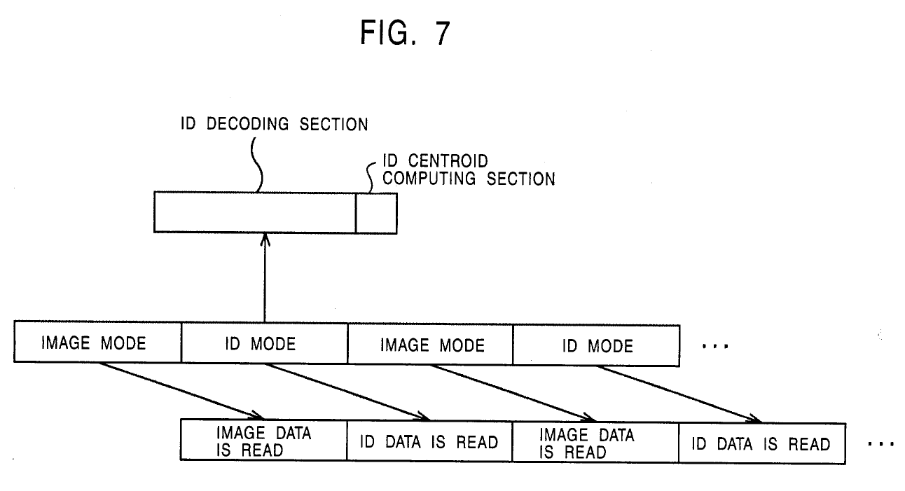

The operation of the comparator 62 differs in the image mode and the ID mode. The operation mode may be switched by a controller (not shown), as shown in FIG. 7, at predetermined time intervals. Alternatively, the operation mode may be switched between the image mode and the ID mode at a known frame rate of 30 fps (frame per second) or 60 fps. The ID mode has an ID decoding section in which the ID data is decoded and an ID centroid computing section in which the position data serving as the coordinate position of a pixel having the decoded ID data is computed.

Referring to FIG. 7, the image mode and the ID mode have the same period of time. Alternatively, each operation mode may or may not have the same time period. As shown in the lower part of FIG. 7, at the time subsequent to each image mode, the image decoding processor 71 decodes a sensor output signal and outputs image data on a captured image. At the time subsequent to each ID mode, the ID decoding processor 72 decodes a sensor output signal and outputs ID data and position data.

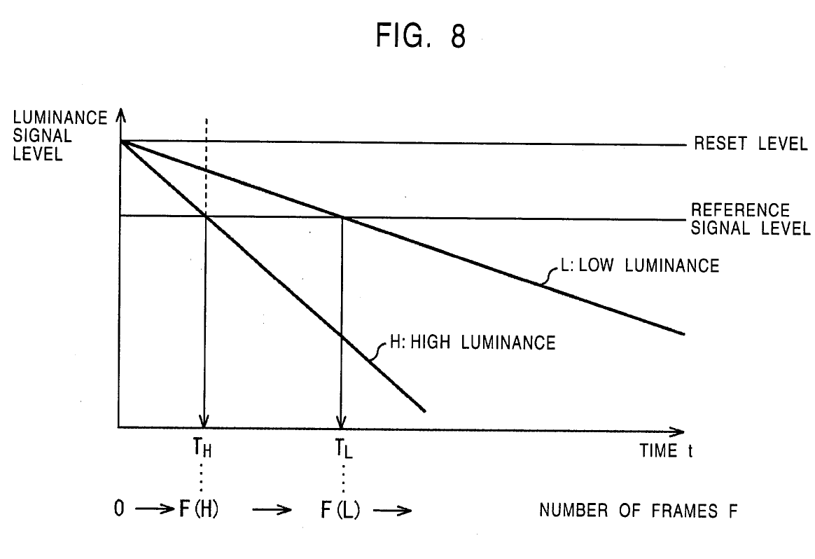

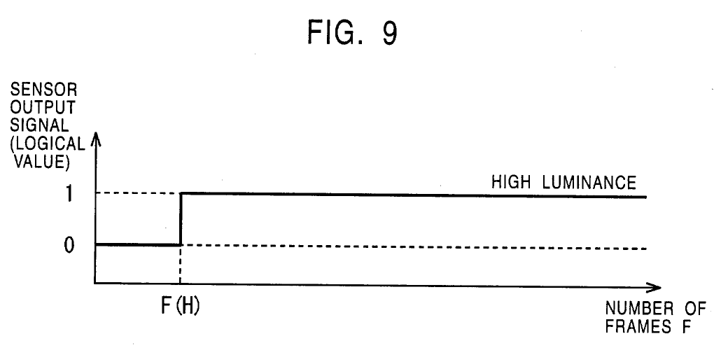

The operation in the image mode will now be described. In the image mode, the comparator 62 of the image sensor 31 compares a signal level indicating each pixel's luminance detected by the light receiving section 41 (electrical signal stored in the storage unit 61) with a reference signal level. Referring to FIG. 9, a signal that becomes active (“1” in FIG. 9) when the luminance signal level becomes lower than the reference signal level, as shown in FIG. 8, is output.

FIG. 8 shows the luminance signal level, and FIG. 9 shows the sensor output signal. The luminance signal level effectively indicates a change in charging voltage of the light receiving element 51. A predetermined reset level voltage, whose polarity is opposite to the charging voltage of the light receiving element 51 applied at a predetermined time, is applied to the light receiving element 51. At a subsequent time, the voltage level decreases in accordance with the electrical charge accumulated by the light receiving element 51. Referring to FIG. 8, zero electrical charge is accumulated at time 0. The luminance signal level is thus the reset level (predetermined level). As time passes from this state, electrical charge is accumulated, and the luminance signal level decreases. In this case, the straight line denoted by H in FIG. 8 refers to a pixel value at a relatively high luminance signal level (bright), and the straight line denoted by L refers to a pixel value at a relatively low luminance signal level (dark).

The pixel value at the high luminance signal level H changes in such a manner that, at time T_{H}, at which period T_{H} has elapsed from time 0, electrical charge reaching the reference signal level is accumulated. In contrast, the pixel value at the low luminance signal level L changes in such a manner that, at time T_{L}, at which period T_{L} has elapsed from time 0, electrical charge reaching the reference signal level is accumulated.

In other words, referring to FIG. 8, the brighter the pixel, the shorter the time it takes to reach the reference signal level (T_{H} in FIG. 8). The darker the pixel, the longer the time it takes to reach the reference signal level (T_{L} in FIG. 8) (T_{H}<T_{L}). The comparator 62 outputs the comparison result (comparator output) indicating whether or not each pixel's electrical signal (luminance signal) output from the light receiving section 41 actually reaches the reference signal level as a binary sensor output signal, as shown in FIG. 9. With such processing, the image sensor 31 captures an image at high speed, compares the image with a reference signal, and outputs the results over one frame as a sensor output signal.

In order to measure the time periods T_{H} and T_{L}, the pixel value determining unit 81 of the image decoding processor 71 counts the results in units of frames, which are output in units of frames by the image sensor 31, encodes the sensor output signal indicating, for each pixel, at which frame the sensor output signal becomes active, as shown in FIG. 9, and outputs the encoded sensor output signal as image data. In this case, the sensor output signal at time T_{H} has the number of frames F(H), and the sensor output signal at time T_{L} has the number of frames F(L).

More specifically, in the image mode, in order to convert the sensor output signal into a value with appropriate luminosity, the pixel value determining unit 81 of the image decoding processor 71 decodes the sensor output signal into image data by computing, for each pixel, the reciprocal of the time (number of frames) required by the sensor output signal to reach the reference signal level and stores the image data in the frame memory 82. After the image data for one frame have been accumulated, the output unit 83 sequentially reads the pixel values stored in the frame memory 82 and outputs the pixel values as image data. With this operation, the ID recognizing camera 11 outputs image data in the image mode (for details, please see ”48 Kframe/s CMOS Image Sensor for Real-time 3-D Sensing and Motion Detection”, ISSCC Digest of Technical Papers, pp. 94-95, February 2001, and Japanese Unexamined Patent Application Publication No. 2001-326857).

When operating in the ID mode, the comparator 62 uses electrical signals over four time-sequential frames, which are stored in the storage unit 61, as luminance signals and performs an arithmetic operation expressed by:

V(N)=F(N)+F(N−1)−F(N−2)−F(N−3) . . . (1)

where N denotes the frame number; V(N) denotes the comparison value at the time the luminance value in the N-th frame is input; and F(N) denotes the luminance accumulated in the light receiving section 41 in the N-th frame. With the arithmetic operation, a change in the light is detected. The operation result is output as a sensor output signal to the data generator 32. The data generator 32 uses the sensor output signal to perform ID decoding, which will be described below, to restore the ID data including the flashing pattern. Accordingly, the ID data from the optical beacon 2 is generated.

The operation performed by the comparator 62 is not limited to equation (1). Alternatively, another operation (such as a first derivation or binary image comparison) is performed. In the following description, it is assumed that equation (1), which is reliable in detecting optical change, is used.

The operation of the ID decoding processor 72 will now be described. The ID decoder circuit 111 of the ID decoder 101 restores each pixel's ID data from the sensor output signal received from the image sensor 31 on the basis of a timing control signal that is received from the timing controller 102 and that is for synchronizing with the timing of the sensor output signal. The ID decoder circuit 111 controls the flag register 112 in accordance with the timing control signal, decodes the ID data from the sensor output signal using the flag data loaded into the frame memory 103, and stores the ID being decoded or the decoded ID in the data register 113. The frame memory 103 stores the decoded flag data and the ID data at the corresponding coordinate position.

The ID register 121 of the centroid calculator 104 causes the ID centroid computing circuit 122 to read the ID data information stored in the frame memory 103 on the basis of the timing control signal, which is received from the timing controller 102 and which indicates that the predetermined ID data is decoded by the ID decoder 101.

The ID centroid computing circuit 122 sequentially adds the I coordinates and the J coordinates at the coordinate positions of pixels corresponding to the read ID data, appends information indicating the number of pixels to the sum of the I coordinates and the sum of the J coordinates, and stores the resultant data in the ID coordinate storage memory 105. This processing is repeated.

When data in one frame is stored in the frame memory 103, the ID centroid computing circuit 122 divides, for each ID, the sum of the I coordinates and the sum of the J coordinates from the ID coordinate storage memory 105 by the number of pieces of data (the number of pixels) to compute the coordinates at the centroid position serving as position data, and outputs the position data along with the corresponding ID data.

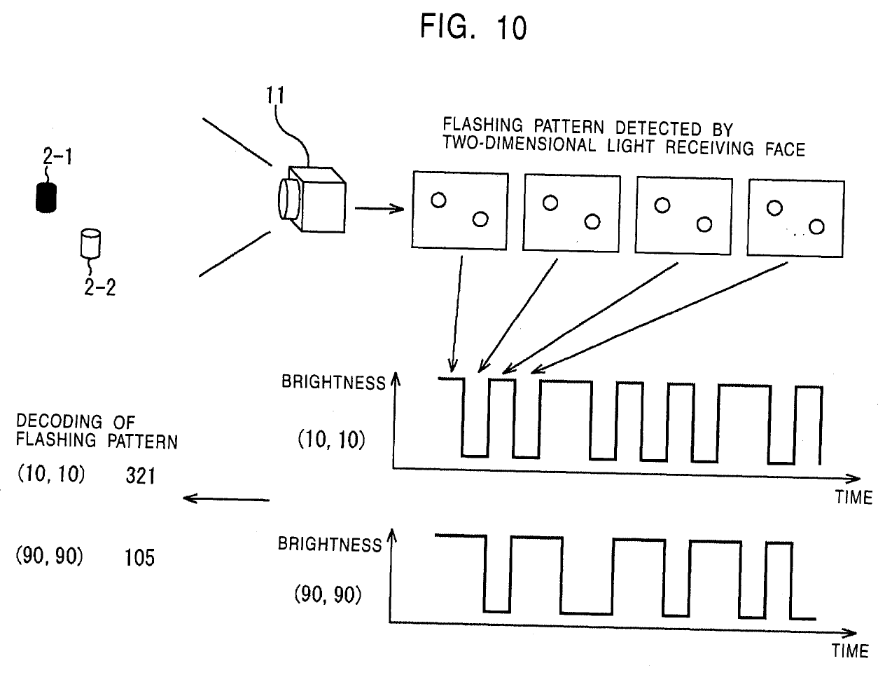

With the above-described operation, for example, as shown in FIG. 10, when the two optical beacons 2-1 to 2-2 transmit data while flashing on and off, the ID recognizing camera 11 receives optical signals at pixels located at positions on the captured image, the positions being associated with the physical positions of the optical beacons 2-1 and 2-2 in real space, as shown in the upper portion of FIG. 10. For example, it is assumed that light emitted from the optical beacon 2-1 is received by the light receiving element 51 at the coordinate position (10, 10), and light emitted from the optical beacon 2-2 is received by the light receiving element 51 at the coordinate position (90, 90). The light receiving elements 51 at the coordinate positions (10, 10) and (90, 90) in the corresponding light receiving sections 41 receive signals serving as temporal changes in the intensity (brightness) of the received light in accordance with the flashing patterns of the optical beacons 2-1 and 2-2, respectively. In this case, the pixel corresponding to the position data at the coordinates (10, 10) has the ID data “321” serving as the decoded result, and the pixel corresponding to the position data at the coordinates (90, 90) has the ID data “105” serving as the decoded result. As a result, binarization of the change in the intensity of the received light in accordance with equation (1) or the like gives ID data consisting of a bit string of 1's and 0's.

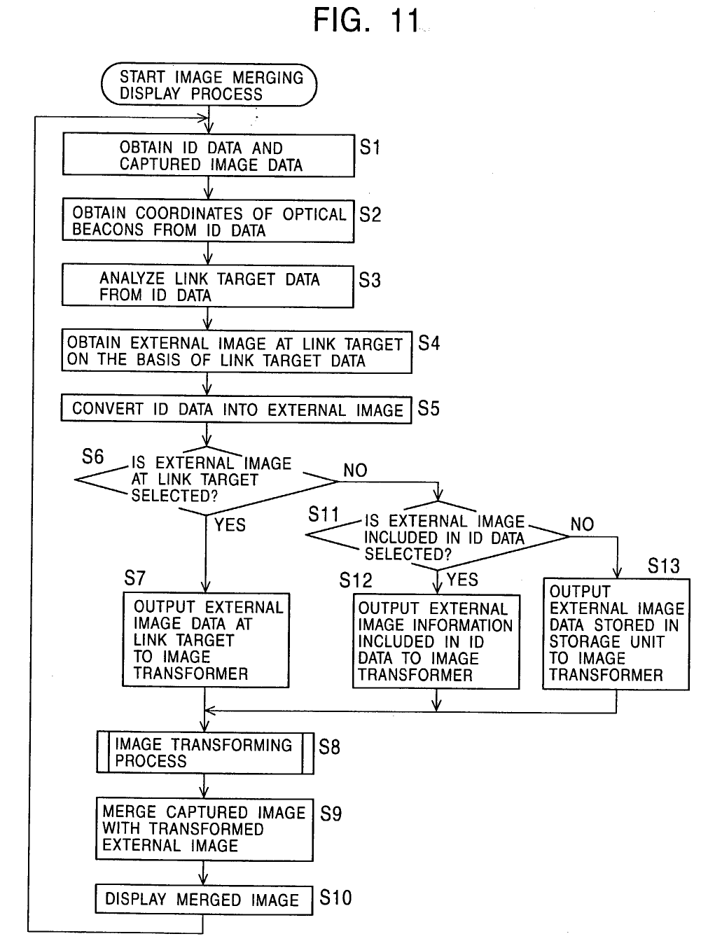

Referring to the flowchart of FIG. 11, an image merging display process by the image merging display apparatus 1 will now be described. In step S1, the ID recognizing camera 11 captures, for example, as shown in FIG. 1, an image of the image capturing area 3, obtains ID data and position data on the optical beacons 2-1 to 2-4 included in the image capturing area 3, generates captured image data on the captured image, and outputs the ID data to the link target data analyzer 16 and the ID image converter 20, the position data to the display position obtaining unit 12, and the captured image data to the image merger 14.

In step S2, the display position obtaining unit 12 obtains a display position at which an external image is to be displayed on the basis of the position data received from the ID recognizing camera 11 and outputs information on the display position to the image transformer 13. Specifically, when an image including the optical beacons 2-1 to 2-4 is captured, a quadrilateral defined by four points corresponding to the optical beacons 2-1 to 2-4 becomes the external image display area 4. Depending on the positional relationship between the ID recognizing camera 11 and the optical beacons 2-1 to 2-4 in real space, the shape of the external image display area 4 on the captured image and the position of the external image display area 4 in the image capturing area 3 change. On the basis of the position data on the optical beacons 2-1 to 2-4 in the image capturing area 3, the display positions for determining the positions of four corners of the external image display area 4 (positions of the optical beacons 2-1 to 2-4 in the image capturing area 3) are obtained.

In step S3, the link target data analyzer 16 analyzes the ID data and outputs the analysis result to the link target image obtaining unit 17. In step S4, when the analysis result of the ID data shows that the ID data includes link target data, the link target image obtaining unit 17 accesses a link target on the basis of the link target data, obtains an external image, and outputs the obtained external image to the external image input unit 18. When the ID data includes no link target data, this processing is skipped. When the ID data includes external image data, in step S5, the ID image converter 20 extracts the external image data, converts the extracted external image data into an external image, and outputs the external image to the external image input unit 18.

In step S6, the external image input unit 18 determines whether or not the input unit 21 is operated to select the external image at the link target. For example, when the external image at the link target is selected, the process proceeds to step S7. In step S7, the external image input unit 18 outputs the external image received from the link target image obtaining unit 17 to the image transformer 13. In step S8, the image transformer 13 transforms the external image received from the external image input unit 18 on the basis of the display position data received from the display position obtaining unit 12, that is, the position data on the four corners of the external image display area 4.

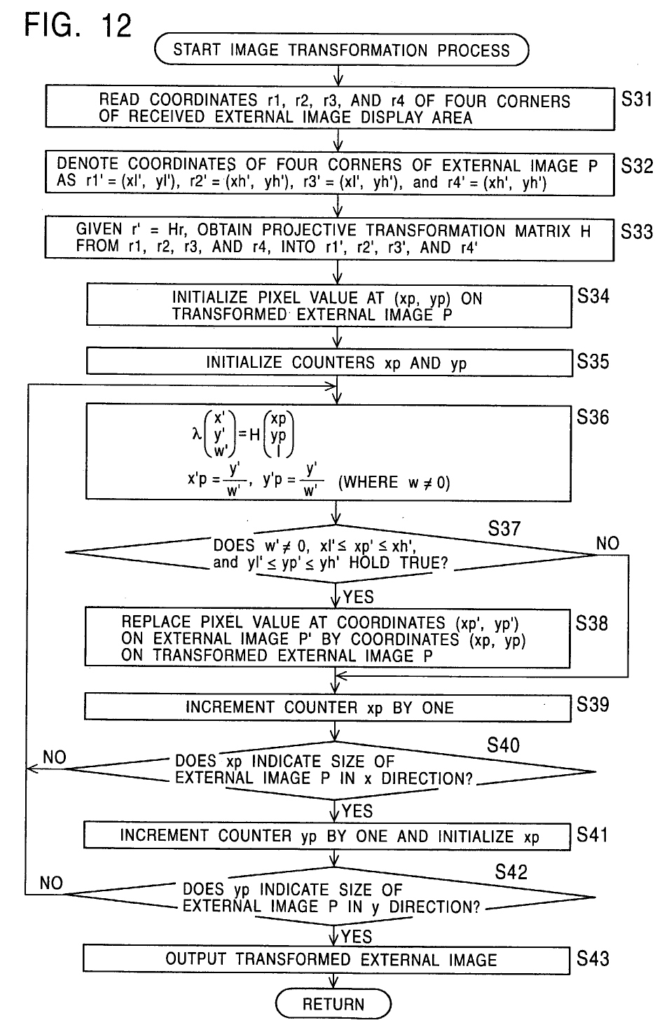

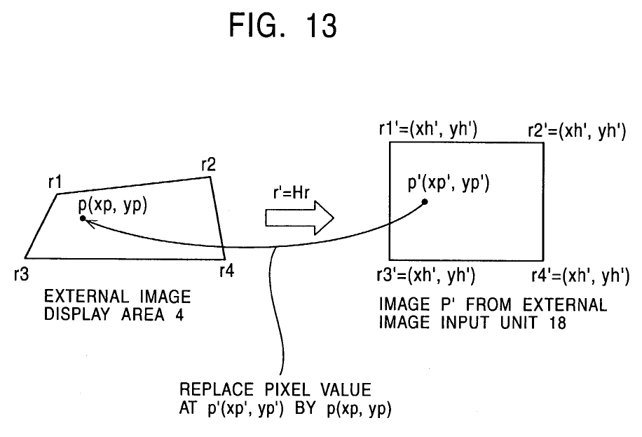

With reference to the flowchart of FIG. 12, an image transformation process will now be described. In step S31, the image transformer 13 reads the coordinates r1, r2, r3, and r4 of four corners of the received external image display area 4 into the memory 13a. In other words, the coordinate positions of the optical beacons 2-1 to 2-4 on the captured image are read into the memory 13a. In step S32, as shown in FIG. 13, the image transformer 13 denotes the coordinates of four corners of an external image P as: r1′=(x1′, y1′), r2′=(xh′, y1′), r3′=(x1′, yh′), and r4′=(xh′, yh′). In step S33, the image transformer 13 expresses the relationship between the coordinates of the four corners of the external image P and the coordinates of the four corners of the received external image display area 4 as r′=Hr.

As is well known, transformation of four points r1, r2, r3, and r4 defining an arbitrary quadrilateral into four points r1′, r2′, r3′, and r4′ defining another arbitrary quadrilateral is represented by projective transformation. Specifically, the coordinates r1, r2, r3, and r4 of the four corners of the received external image display area 4 are transformed into the coordinates r1′, r2′, r3′, and r4′ of four corners of the image from the external image input unit 18:

$$\begin{matrix}\begin{matrix}H = [ \begin{matrix}{h}_{0} & {h}_{1} & {h}_{2} \\ {h}_{3} & {h}_{4} & {h}_{5} \\ {h}_{6} & {h}_{7} & {h}_{8}\end{matrix} ] \\ {r}^{′} = {( \begin{matrix}{x}^{′} & {y}^{′} & {w}^{′}\end{matrix} )}^{T}\end{matrix} \\ r = {( \begin{matrix}{x}_{p} & {y}_{p} & 1\end{matrix} )}^{T}\end{matrix} \qquad ( 2 )$$

λr′=Hr (3)

$${x}_{p}^{′} = \frac{{x}^{′}}{{w}^{′}} , {y}_{p}^{′} = \frac{{y}^{′}}{{w}^{′}} ( {w}^{′} \neq 0 \qquad ( 4 )$$

where r denotes the homogeneous coordinates prior to the projective transformation, that is, the coordinates (xp, yp) on the received external image display area; and r′ denotes the homogeneous coordinates subsequent to the projective transformation, that is, the coordinates (xp′, yp′) on the image from the external image input unit 18. By substituting the coordinates (xp, yp) of the four corners of the received external image display area 4 and the corresponding coordinates (xp′, yp′) of the four corners of the image from the external image input unit 18 for equation (3), the matrix H is calculated.

In step S34, the image transformer 13 initializes all areas of the memory 13a corresponding to the output image data P (px, py). In other words, all areas in which the transformed external image is stored are initialized. In step S35, the image transformer 13 initializes built-in counters xp and yp. In step S36, the image transformer 13 computes a point (xp′, yp′) corresponding to a point (xp, yp) in the received external image display area 4 using equations (3) and (4).

In step S37, in a case in which w′≠0, if the computed xp′ and yp′ are within the area defined by the four corners of the external image P, that is, if w′≠0, x1′≦xp′≦xh′, and y1′≦yp′≦yh′ hold true, in step S38, the image transformer 13 replaces the pixel value at the coordinates (xp′, yp′) on an external image P′ by the pixel value at the coordinates (xp, yp) on the external image display area 4 and stores the replaced pixel value in the memory 13a. In other words, as shown in FIG. 13, the pixel value of the external image displayed on the external image display area 4 is determined.

In step S39, the image transformer 13 increments the counter xp by one. In step S40, it is determined whether or not the current value of the counter xp matches the size of the external image display area 4 in the x direction. If the determination is negative, the process returns to step S36. If it is determined in step S40 that the current value of the counter xp matches the size of the external image display area 4 in the x direction, the process proceeds to step S41.

In step S41, the image transformer 13 increments the counter yp by one and initializes the counter xp. In step S42, it is determined whether or not the current value of the counter yp matches the size of the external image display area 4 in the y direction. If the determination is negative, the process returns to step S36. If it is determined in step S42 that the current value of the counter yp matches the size of the external image display area 4 in the y direction, that is, if all the coordinates within the external image display area 4 are subjected to the processing in steps S36 to S38 due to the processing in step S39 to S42, in step S43, the image transformer 13 outputs the transformed external image stored in the memory 13 a to the image merger 14.

When w′≠0, x1′≦xp′≦xh′, and yl′≦yp′≦yh′ do not hold true in step S37, the computed xp′ and yp′ are not within the area defined by the four corners of the external image P. Therefore, the processing in step S38 is skipped. In other words, the computed xp′ and yp′ are not the coordinates within the external image display area 4, and the pixel value replacement processing is thus skipped.

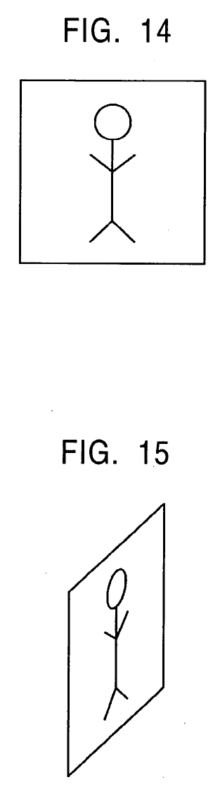

The above-described process is to perform projective transformation. With the projective transformation, each pixel value of the external image is replaced by the pixel value in the external image display area 4 being transformed depending on the image-captured positions, thus effectively transforming the external image. In other words, for example, when an external image shown in FIG. 14 is used, if the external image display area 4 shown in FIG. 1 is formed, the external image shown in FIG. 14 is transformed, as shown in FIG. 15, into the shape of the external image display area 4 shown in FIG. 1.

The description returns to the flowchart of FIG. 11. In step S9, the image merger 14 merges the transformed external image with the captured image to generate a merged image and outputs the merged image to the image display unit 15. In step S10, the image display unit 15 displays the merged image received from the image merger 14. The process returns to step S1, and the processing from this step onward is repeated.

When it is determined in step S6 that the image at the link target is not selected, in step S11, the external image input unit 18 determines whether or not the input unit 21 is operated to select the external image generated from the external image data included in the ID data. When the external image included in the ID data is selected, the process proceeds to step S12.

In step S12, the external image input unit 18 reads the external image included in the ID data received from the ID image converter 20 and outputs the external image to the image transformer 13. The process proceeds to step S8.

If it is determined in step S11 that the image included in the ID data is not selected, in step S13, the external image input unit 18 reads the external image that is stored in advance in the storage unit 19 and outputs the external image to the image transformer 13. The process proceeds to step S8.

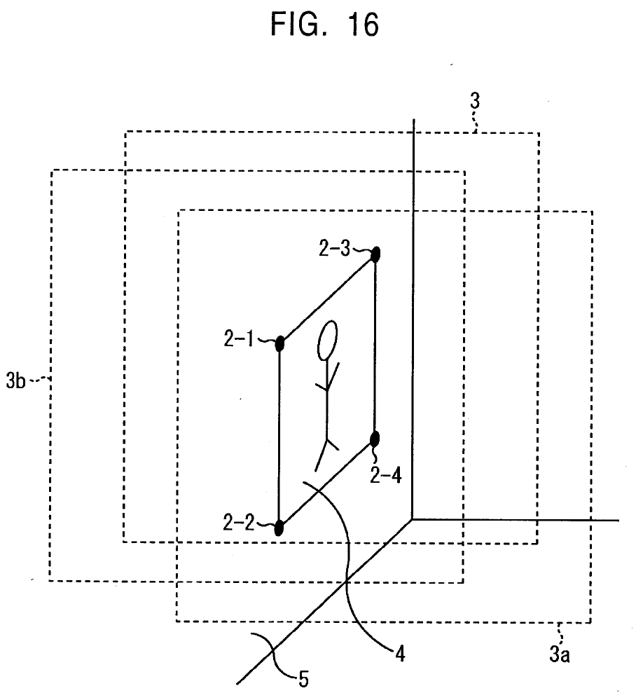

With the above-described process, for example, as shown in FIG. 15, the transformed external image is merged, as shown in FIG. 16, and an image displayed on the image capturing area 3 is displayed on the image display unit 15. Since the process is repeated, even when the direction of the ID recognizing camera 11 changes to change the image capturing area 3 to, as shown in FIG. 16, an image capturing area 3a or 3b, the external image display area 4 remains within the rectangle defined by the optical beacons 2-1 to 2-4. As a result, an image is displayed as if a screen displaying the image were provided on the wall 5. Since the external image display area 4 is determined by the positions of the optical beacons 2 in the image capturing area 3, so-called calibration for defining beforehand the positional relationship between the image merging display apparatus 1 and the optical beacons 2 is unnecessary. Accordingly, use of the system becomes easier.

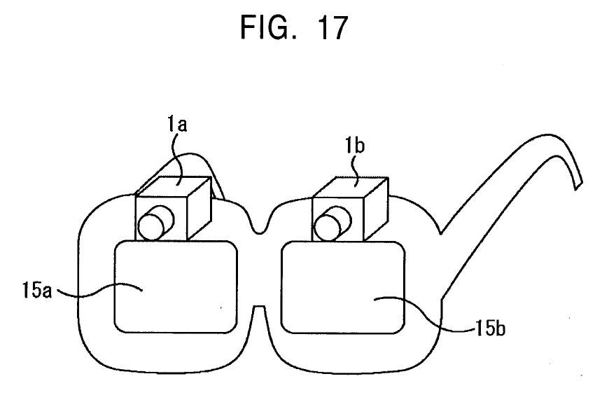

Referring to FIG. 17, the image merging display apparatus 1 may be in the shape of eyeglasses, thus serving as a so-called HMD. In other words, an HMD shown in FIG. 17 includes a pair of image merging display apparatuses 1a and 1b and a pair of display units 15a and 15b (images are displayed toward the rear of the drawing on the page) in accordance with the parallax between the left and right eyes.

With this arrangement, the image merging display apparatuses 1a and 1b, which are associated with the parallax between the left and right eyes, each capture an image of the optical beacons 2. The external image display area 4 thus represents the parallax between the left and right eyes, making the displayed external image appear three-dimensional.

The display units 15a and 15b may have so-called “see-through” or transparent structures. Specifically, the display units 15a and 15b each have a light shielding portion that blocks light from entering the external image display area 4 and that displays an external image and a “see-through” (transparent or semi-transparent) portion allowing the user to see through the display units 15a and 15b. With this arrangement, the captured image need not be displayed, and thus processing by the image merger 14 becomes unnecessary. Only the external image needs to be displayed on the external image display area 4. Since the display units 15a and 15b have “see-through” structures, the user experiences less stress as a result of feeling confined in a small and enclosed space even when the user is wearing the HMD. Moreover, the user can view the merged image in any posture.

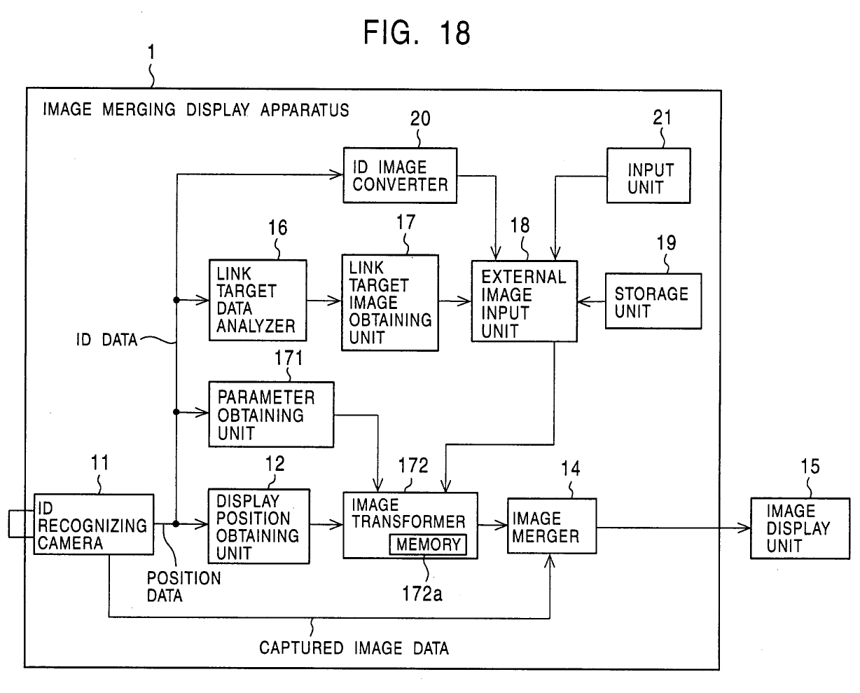

With reference to the block diagram of FIG. 18, another example of the configuration of an image merging display apparatus 1 for adding parameters s and t to data emitted from the optical beacons 2 and causing the optical beacons 2 to emit light in accordance with predetermined flashing patterns will now be described. Referring to FIG. 18, the same reference numerals are given to components corresponding to those of the image merging display apparatus 1 in FIG. 1, and repeated descriptions of the common portions are omitted.

Basically, the configuration of the image merging display apparatus 1 shown in FIG. 18 is similar to that shown in FIG. 1 except for the fact that a parameter obtaining unit 171 is provided and that an image transformer 172 is provided in place of the image transformer 13. The parameter obtaining unit 171 obtains parameters s and t included in the ID data emitted from each of the optical beacons 2 and outputs the parameters s and to the image transformer 172. The image transformer 172 divides the external image received from the external image input unit 18 into a plurality of areas on the basis of the parameters s and t received from the parameter obtaining unit 171, transforms the individual areas of the external image, and outputs the transformed areas to the image merger 14.

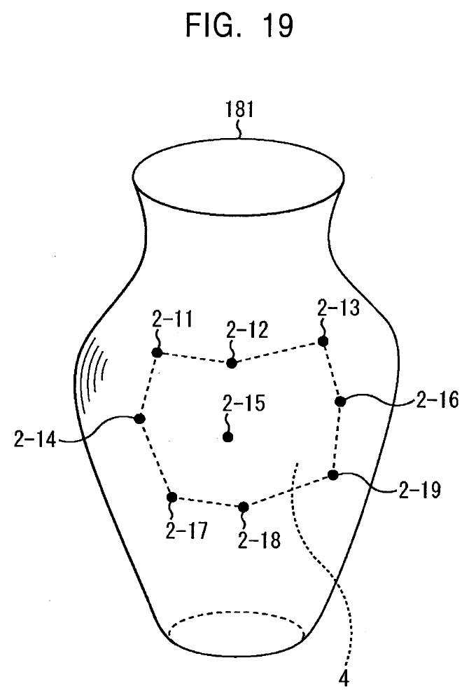

Referring to FIG. 19, it is assumed that optical beacons 2-11 and 2-19 are provided on a curved surface of a vase 181. Along the curved surface of the vase 181, the optical beacons 2-11 and 2-19 are arranged in such a manner that the optical beacons 2-11 to 2-13; 2-14 to 2-16; 2-17 to 2-19; 2-11, 2-14, and 2-17; 2-12, 2-15, and 2-19 are arranged at regular intervals. (If the surface of the vase 181 is a flat surface, the optical beacons 2-11 to 2-19 are arranged in a grid. However, since the optical beacons 2-11 to 2-19 are arranged along the curved surface, the grid is slightly distorted.) In this case, the external image display area 4 is, as shown in FIG. 19, a region defined by the optical beacons 2-11 to 2-14 and 2-16 to 2-19, when viewed from the image-captured positions.

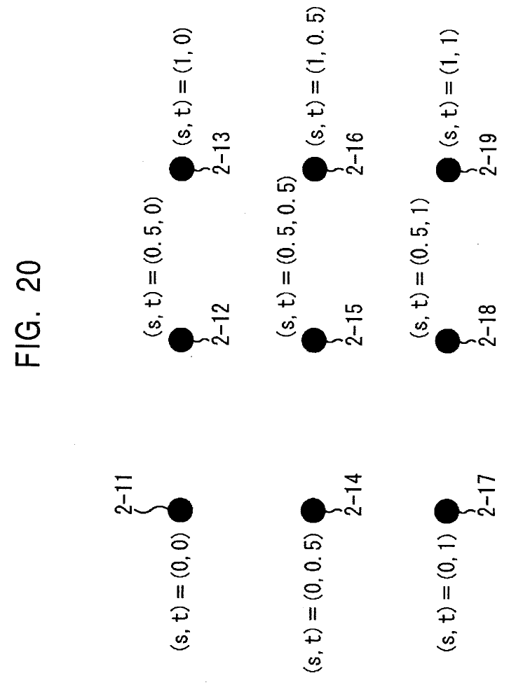

In this state, the optical beacons 2-11 to 2-19 emit light in accordance with predetermined flashing patterns including the parameters s and t indicating their positions on the external image. For example, as shown in FIG. 20, the parameters (s, t) of the optical beacons 2-11 to 2-19 are (0, 0), (0.5, 0), (1, 0), (0, 0.5), (0.5, 0.5), (0, 1) (0.5, 1), and (1, 1), respectively.

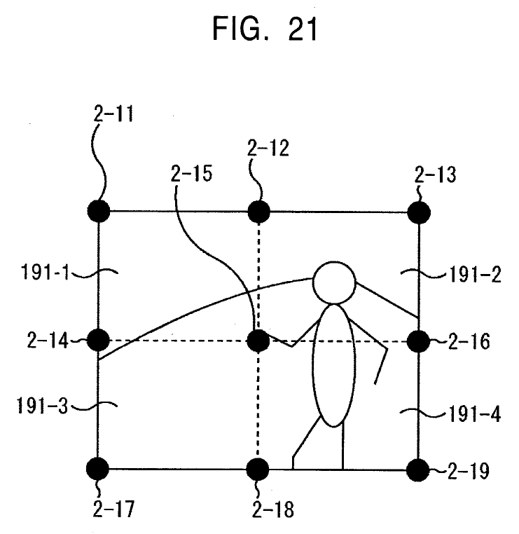

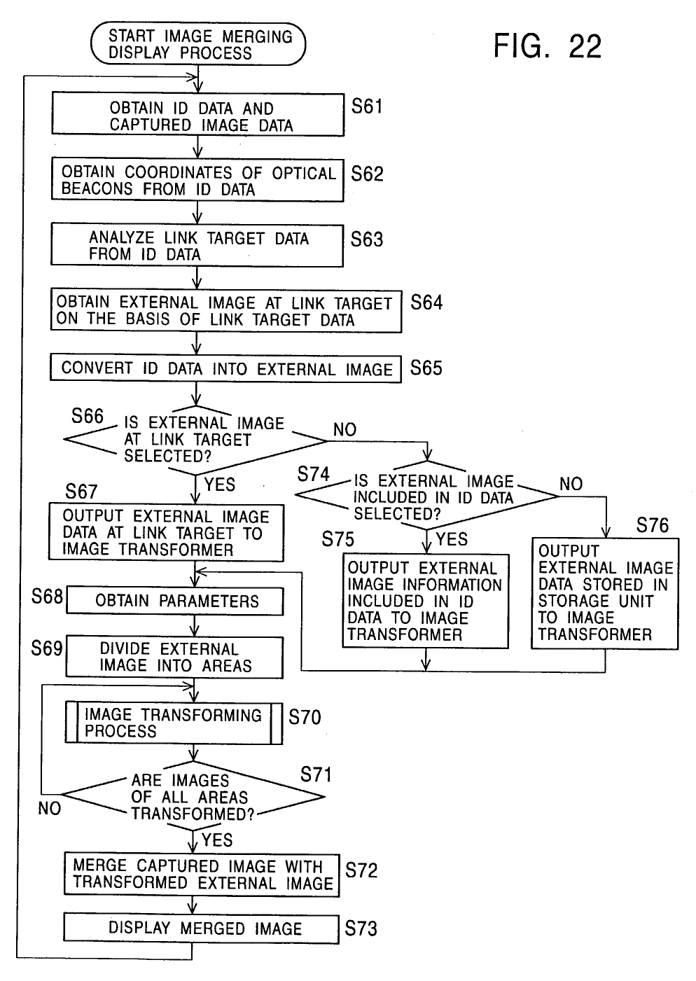

With reference to the flowchart of FIG. 22, an image merging display process for displaying an external image shown in FIG. 21 on the external image display area 4 shown in FIG. 19 will now be described. Since the processing in steps S61 to S67, S70, and S72 to S76 is similar to steps S1 to S13 of FIG. 11, descriptions thereof are omitted.

In step S68, the parameter obtaining unit 171 obtains information on parameters s and t from the ID data and outputs the obtained parameters s and t to the image transformer 172. Specifically, in this case, the parameter obtaining unit 171 obtains, for the optical beacons 2-11 to 2-19, the parameters (s, t), that is, (0, 0), (0.5, 0), (1, 0), (0, 0.5), (0.5, 0.5), (1, 0.5), (0, 1), (0.5, 1), and (1, 1), and outputs the obtained parameters (s, t) to the image transformer 172.

In step S69, the image transformer 172 divides, as shown in FIG. 21, the external image data into areas 191-1 to 191-4 on the basis of the parameters s and t. Specifically, in this case, the image transformer 172 divides the received external image into four areas 191-1 to 191-4, whose size is half the length of each side of the original external image.

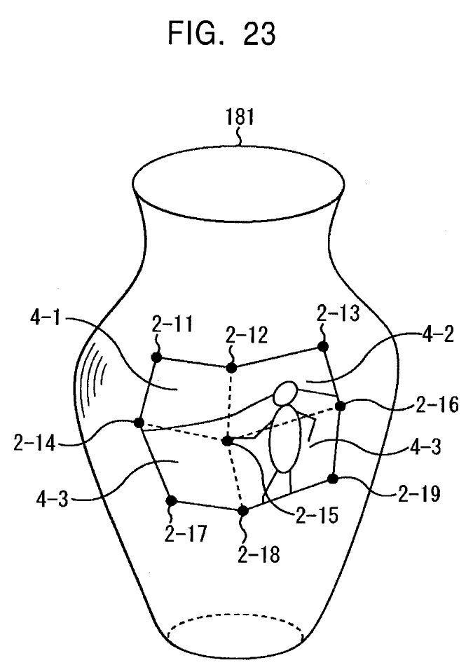

In step S70, the image transformer 172 individually transforms the separate areas 191-1 to 191-4. In step S71, the image transformer 172 determines, as shown in FIG. 23, whether or not all the areas 191-1 to 191-4 are transformed to fit external image display areas 4-1 to 4-4, respectively. The transformation processing in step S70 is repeated until all the areas 191 are transformed.

With this processing, as shown in FIG. 23, the image display unit 15 generates a display effect for the user as if the external image were displayed along the curved surface of the vase 181 (as if the external image fits the curved surface). In the above case, there are nine optical beacons 2. The number of optical beacons 2 may be greater. In the case of providing such optical beacons 2 on a curved surface, the larger the curvature of the curved surface, the more numerous the optical beacons 2 provided. As a result, an external image is merged with the curved surface more smoothly (fits the curved surface more properly).

In the above example, one external image is merged with the captured image. Alternatively, a plurality of external images is displayed.

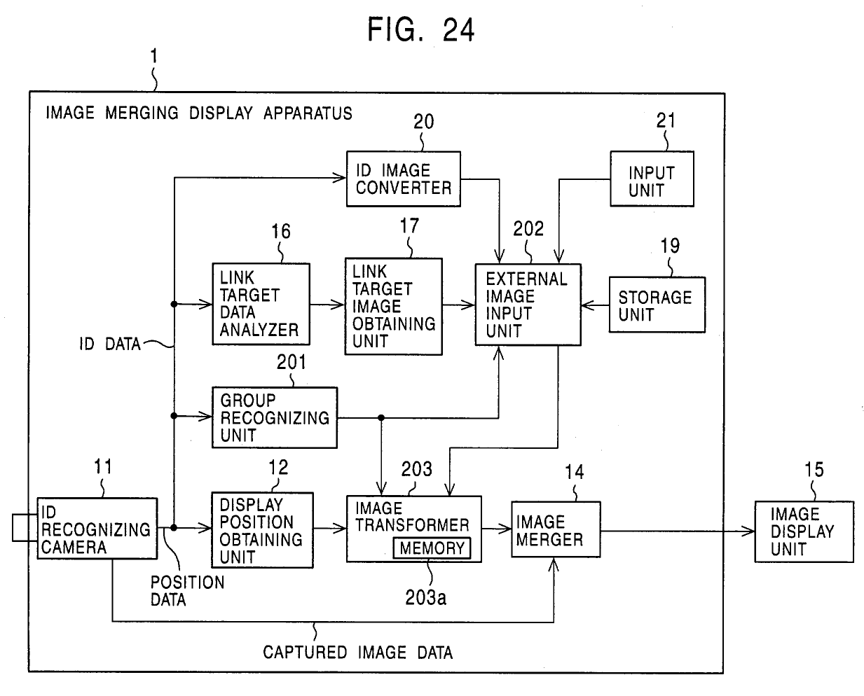

FIG. 24 shows an image merging display apparatus 1 for displaying a plurality of external images. Referring to FIG. 24, the same reference numerals are given to components corresponding to those of the image merging display apparatus 1 in FIG. 1, and repeated descriptions of the common portions are appropriately omitted. Basically, the configuration of the image merging display apparatus 1 shown in FIG. 24 is similar to that shown in FIG. 1 except for the fact that a group recognizing unit 201 is additionally provided, that an external image input unit 202 is provided in place of the external image input unit 18, and an image transformer 203 is provided in place of the image transformer 13.

The group recognizing unit 201 reads group identifying data for the optical beacons 2 associated with each external image display area 4, the group identifying data being included in the ID data, and outputs the group identifying data to the external image input unit 202 and the image transformer 203. More specifically, the group recognizing unit 201 distinguishes each group (external image) by adding a group number to each group (external image) identified by the group identifying data.

The external image input unit 202 reads external images designated by the user by operating the input unit 21, the designated external images being one of external images obtained from a link target for each group identifying data, external images included in the ID data received from the ID image converter 20, and external images that are stored in advance in the storage unit 19, and outputs the read external images to the image transformer 203.

For each group, the image transformer 203 transforms the external images (external image data received from the external image input unit 202 ) on the basis of the group identifying data and outputs the transformed external images to the image merger 14.

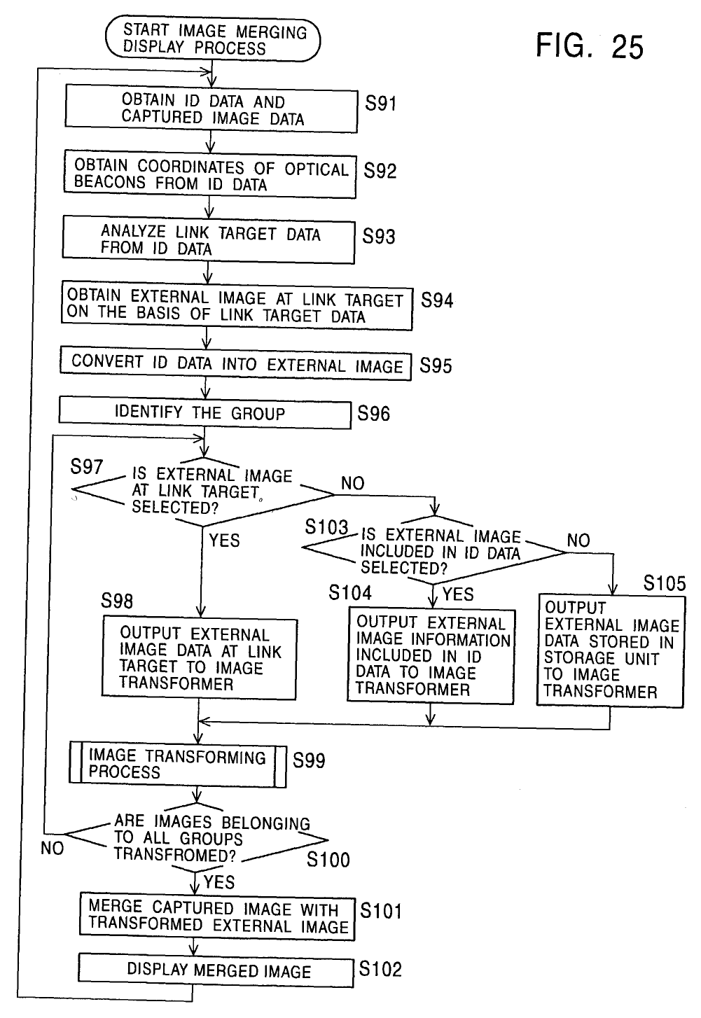

With reference to the flowchart of FIG. 25, an image merging display process of merging and displaying a plurality of external images will now be described. Since the processing in steps S91 to S95, S97 to S99, and S101 and S105 is similar to the processing in step S1 to S13 of the flowchart shown in FIG. 11, descriptions thereof are omitted.

In step S96, the group recognizing unit 201 obtains group identifying data included in the ID data for all the individual optical beacons 2 and outputs the group identifying data to the external image input unit 202 and the image transformer 203. Subsequent to the processing in step S97 to S99 and S103 to S105, in step S100, the image transformer 203 determines whether or not external images belonging to all groups are transformed. If it is determined that not all external images are transformed, the process returns to step S97. The processing in step S97 to S99 and S103 to S105 is repeated until it is determined that all external images are transformed. When it is determined in step S100 that external images belonging to all groups are transformed, the process proceeds to step S101. The processing from step S101 onward is repeated.

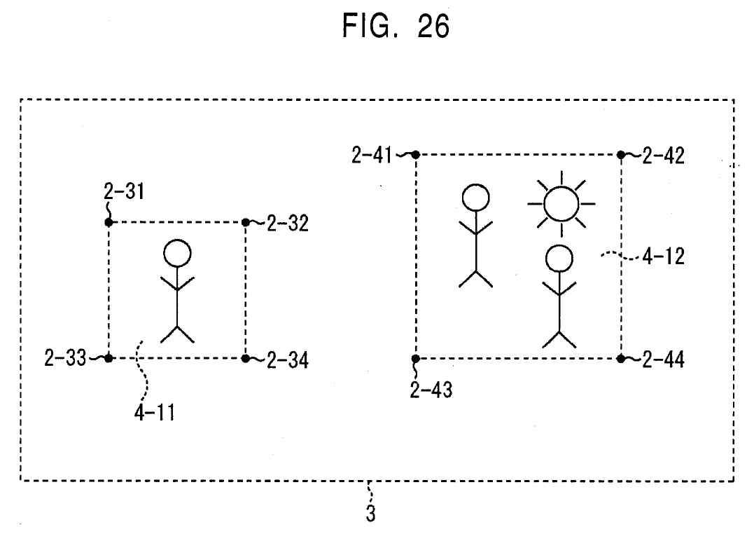

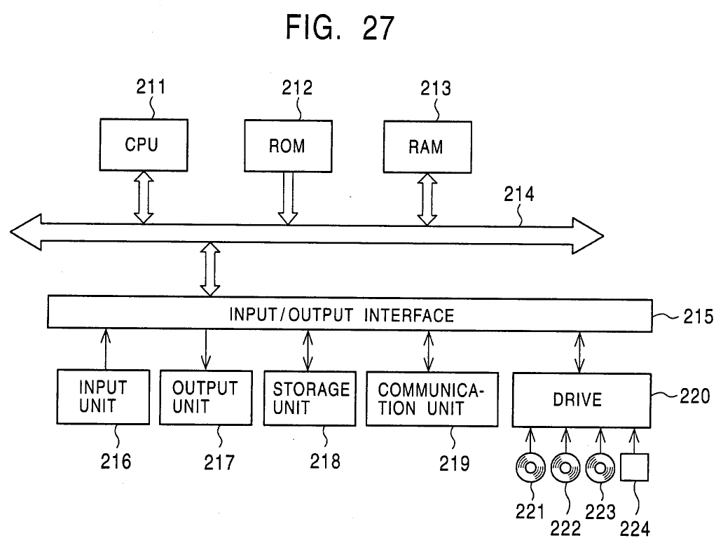

With the above-described process, for example, as shown in FIG. 26, external image A is displayed on an external image display area 4-11 defined by optical beacons 2-31 to 2-34, and external image B is displayed on an external image display area 4-12 defined by optical beacons 2-41 to 2-44. Two external images A and B are thus displayed. In this case, the group identifying data indicating that the optical beacons 2-31 to 2-34 belong to the same group forming the external image display area 4-11 and the group identifying data indicating that the optical beacons 2-41 to 2-44 belong to the same group forming the external image display area 4-12 are included and transmitted with the ID data. The image merging display apparatus 1 generates external image display areas associated with the corresponding groups in accordance with the group identifying data included in the ID data and merges and displays individual external images. The number of external images to be displayed may be greater than the number in the above example.

With the foregoing processing, the parameters s and t of each of the optical beacons 2 on the external image are transmitted as the ID data. An external image is transformed and displayed as if it were displayed on a curved surface in real space. Accordingly, an image is merged and displayed as if it were displayed on a curved surface in real space.

According to the present invention, the optical beacons are arranged in real space, and an external image is transformed and merged in accordance with the arrangement of the optical beacons on a captured image. This generates an effect as if the merged external image were displayed in real space.

Since the group identifying data is included in the ID data transmitted from the optical beacons by emitting light, a plurality of external images is simultaneously merged and displayed.

Since the ID data includes the link target data to an external image to be displayed, changing the data transmitted from the optical beacons 2 causes a different external image to be merged and displayed.

Since the data transmitted from the optical beacons includes image data, an external image is merged and displayed without providing another communication medium for receiving an external image.

Since an HMD including a pair of image merging display apparatuses 1 is provided while taking into consideration the parallax between the human eyes, a merged external image represents the parallax between the eyes. As a result, the external image with high realism and impressive quality is merged and displayed.

Since a plurality of optical beacons having parameters indicating their positions on the external image are arranged on a curved surface in real space, an external image is merged and displayed in such a manner that the external image fits the curved surface more satisfactorily.

The above described series of processes can be performed by hardware or by software. When performing the series of processes by software, a program including the software is installed from a recording medium or the like into a computer included in dedicated hardware or into a general-purpose personal computer capable of executing various programs by installing such various programs.

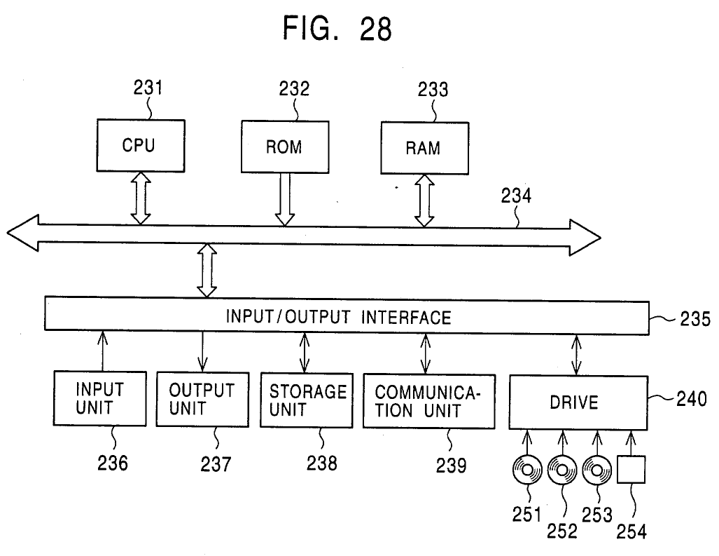

FIG. 27 shows the configuration of an embodiment of a personal computer in a case in which the image merging display apparatus 1 is implemented using software. FIG. 28 shows the configuration of an embodiment of a personal computer in a case in which the optical beacons 2 are implemented using software. CPUs 211 and 231 of the personal computers control the overall operation of the personal computers. The CPU 211 and 231 execute programs stored in ROMs (Read Only Memory) 212 and 232 in response to commands input from users through input units 216 and 236 including keyboards and mice via buses 214 and 234 and input/output interfaces 215 and 235. Alternatively, the CPUs 211 and 231 load into RAMs (Random Access Memory) 203 and 233 programs that are read from magnetic disks 221 and 251, optical disks 222 and 252, magneto-optical disks 223 and 253, or semiconductor memories 224 and 254 connected to drives 220 and 240 and that are installed in storage units 208 and 238 and the CPUs 211 and 231 execute the programs, and output units 217 and 237 output the execution results. The CPUs 211 and 231 control communication units 219 and 239 to communicate with the outside and exchange data.

As shown in FIGS. 27 and 28, the recording media having recorded thereon the programs include not only packaged media that are distributed to provide the programs to the users, including the magnetic disks 221 and 251 (including flexible disks), the optical disks 222 and 252 (including CD-ROM (Compact Disc-Read Only Memory) and DVD (Digital Versatile Disc), the magneto-optical disks 223 and 253 (including MD (Mini-Disc)), or the semiconductor memories 234 and 254 having recorded thereon the programs, but also include the ROMs 212 and 232 and hard disks included in the storage units 218 and 238, which have recorded thereon the programs and which are incorporated in advance in the computers and provided to the users.

In the present description, the steps for writing the programs provided by the recording media include not only time-series processing performed in accordance with the described order but also include parallel or individual processing, which may not necessarily be performed in time series. In the present specification, the system refers to the entirety of an apparatus including a plurality of apparatuses.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. An image display apparatus comprising:
image capturing means for capturing an image of a plurality of transmitting apparatuses that emit light in predetermined flashing patterns to transmit data;
detection means for detecting the image-captured positions of the plurality of transmitting apparatuses from position data obtained from the image capturing means;
input means for inputting a first image;
transformation means for transforming the first image to correspond to a shape obtained on the basis of the image-captured positions of the transmitting apparatuses; and
display means for displaying the first image transformed by the transformation means at a display position associated with the image-captured positions of the transmitting apparatuses.

2. An image display apparatus according to claim 1, further comprising analysis means for analyzing the data included in the predetermined flashing patterns emitted by the plurality of transmitting apparatuses.

3. An image display apparatus according to claim 2, wherein the data includes link data, content data, or group data indicating a group to which the plurality of transmitting apparatuses belong.

4. An image display apparatus according to claim 3, wherein the link data includes a link target on a network, in which information on the first image resides.

5. An image display apparatus according to claim 4, further comprising obtaining means for accessing the link target included in the link data and obtaining the first image.

6. An image display apparatus according to claim 3, wherein the content data includes information on the first image.

7. An image display apparatus according to claim 6, wherein the input means inputs the first image included in the content data.

8. An image display apparatus according to claim 3, wherein the transformation means transforms the first image on the basis of the image-captured positions of four transmitting apparatuses including the same group data, and
when the first image is a quadrilateral, the display means displays the first image transformed by the transformation means at the display position so that four corners of the first image are associated with the image-captured positions of the four transmitting apparatuses.

9. An image display apparatus according to claim 1, wherein the image capturing means captures a second image, in addition to the image of the plurality of transmitting apparatuses emitting light in the predetermined flashing patterns to transmit the data.

10. An image display apparatus according to claim 9, further comprising merged image generating means for merging the second image with the first image transformed by the transformation means and generating a merged image,
wherein the display means displays the merged image so that the first image included in the merged image is displayed at the display position associated with the image-captured positions of the transmitting apparatuses.

11. An image display apparatus according to claim 1, wherein the display means includes:
a transparent screen; and
light-shielded-area generating means for generating a light-shielded area at the display position associated with the image-captured positions of the transmitting apparatuses on the screen, and
the first image transformed by the transformation means is displayed in the light-shielded area.

12. An image display apparatus according to claim 1, wherein the image capturing means, the input means, the transformation means, and the display means are provided on a pair of glasses.

13. An image display apparatus according to claim 1, wherein a refresh rate of the image capturing means is higher than a refresh rate of the display means.

14. An image display apparatus according to claim 1, wherein the transformation means transforms the first image by projective transformation based on the image-captured positions of the transmitting apparatuses.

15. An image display method comprising:
an image capturing step of capturing an image of a plurality of transmitting apparatuses that emit light in predetermined flashing patterns to transmit data;
a detection step of detecting the image-captured positions of the plurality of transmitting apparatuses;
an input step of inputting a first image;
a transformation step of transforming the first image to correspond to a shape obtained on the basis of the image-captured positions of the transmitting apparatuses; and
a display step of displaying the first image transformed in the transformation step at a display position associated with the image-captured positions of the transmitting apparatuses.

16. A recording medium having recorded thereon a computer-readable program, the program comprising:
an image capturing control step of controlling capturing of an image of a plurality of transmitting apparatuses that emit light in predetermined flashing patterns to transmit data;
a detection control step of controlling detection of the image-captured positions of the plurality of transmitting apparatuses;
an input control step of controlling inputting of a first image;
a transformation control step of controlling transformation of the first image to correspond to a shape obtained on the basis of the image-captured positions of the transmitting apparatuses; and
a display control step of controlling displaying of the transformed first image at a display position associated with the image-captured positions of the transmitting apparatuses.

17. A program for causing a computer to perform a process comprising:
an image capturing control step of controlling capturing of an image of a plurality of transmitting apparatuses that emit light in predetermined flashing patterns to transmit data;
a detection control step of controlling detection of the image-captured positions of the plurality of transmitting apparatuses;
an input control step of controlling inputting of a first image;
a transformation control step of controlling transformation of the first image to correspond to a shape obtained on the basis of the image-captured positions of the transmitting apparatuses; and
a display control step of controlling displaying of the transformed first image at a display position associated with the image-captured positions of the transmitting apparatuses.

18. A transmitting apparatus for transmitting data by emitting light in a predetermined flashing pattern, comprising;
pattern generating means for generating the predetermined flashing pattern associated with the data; and
light-emitting means for emitting light in the predetermined flashing pattern generated by the pattern generating means.

19. A transmitting apparatus according to claim 18, wherein the data includes link data, content data, or group data indicating a group to which the transmitting apparatus belongs.

20. A transmitting apparatus according to claim 19, wherein the link data includes a link target on a network, in which information on an image displayed on an image display apparatus resides.

21. A transmitting apparatus according to claim 19, wherein the content data includes information on an image displayed on an image display apparatus.

22. A transmitting method for a transmitting apparatus that transmits data by emitting light in a predetermined flashing pattern, comprising;
a pattern generating step of generating the predetermined flashing pattern associated with the data; and
a light-emitting step of emitting light in the predetermined flashing pattern generated in the pattern generating step.

23. A recording medium having recorded thereon a computer-readable program for controlling a transmitting apparatus that transmits data by emitting light in a predetermined flashing pattern, the program comprising;
a pattern generation control step of controlling generation of the predetermined flashing pattern associated with the data; and
a light-emission control step of controlling emission of light in the predetermined flashing pattern generated in the pattern generation control step.

24. A program for causing a computer that controls a transmitting apparatus that transmits data by emitting light in a predetermined flashing pattern to perform a process comprising:
a pattern generation control step of controlling generation of the predetermined flashing pattern associated with the data; and
a light-emission control step of controlling emission of light in the predetermined flashing pattern generated in the pattern generation control step.

25. An image display system comprising;
an image display apparatus including,
image capturing means for capturing an image of the plurality of transmitting apparatuses that emit light in predetermined flashing patterns to transmit data;
detection means for detecting the image-captured positions of the plurality of transmitting apparatuses;
input means for inputting an image;
transformation means for transforming the image to correspond to a shape obtained on the basis of the image-captured positions of the transmitting apparatuses; and
display means for displaying the image transformed by the transformation means at a display position associated with the image-captured positions of the transmitting apparatuses,
wherein each of the plurality of transmitting apparatuses includes,
pattern generating means for generating the predetermined flashing pattern associated with the data; and
light-emitting means for emitting light in the predetermined flashing pattern generated by the pattern generating means.
